(19) United States
(12) Patent Application Publication
(10) Pub. No.: US 2025/0121780 A1
(43) Pub. Date: Apr. 17, 2025

(54) INTERIOR DOOR GUARD

(71) Applicant: 4Knines, LLC, Oklahoma City, OK (US)

(72) Inventor: James Umlauf, Glendale, AZ (US)

(21) Appl. No.: 18/485,757

(22) Filed: Oct. 12, 2023

(51) Int. Cl. B60R 13/02

(52) U.S. Cl. CPC B60R 13/0243; B60R 13/0206

(57) ABSTRACT

Systems and methods for providing and using a door guard for protecting an interior of a car door are provided. In some cases, the door guard includes a cover configured to at least partially cover a door panel, and a coupling system for selectively attaching the cover to the interior of the car door. In some cases, the coupling system includes a fastener and a complementary fastener that can be selectively attached to the fastener at a plurality of points. In some cases, the coupling system includes an anchoring system coupled to the complementary fastener.

### FIELD

The present disclosure relates to protective covers for surfaces, and more particularly to protective covers configured to shield an interior vehicle door from spills, damage, dust, pet hair, or other harm.

### BACKGROUND

Many covers exist to shield the interior of a vehicle from spills, damage, dust, pet hair, or other harm that may come to the vehicle interior through transportation of a pet or other ordinary vehicle use. For example, cars often have floor mats to protect carpets or other floor surfaces, and seat covers are generally available to protect seat surfaces. Unfortunately, however, protection for interior car doors is more limited. Moreover, car doors are particularly vulnerable to scratches, spills, and other damage and dirtying because doors are often opened through pushing on the interior surface. Additionally, objects and passengers in a car, each of which can cause damage or dirtying, are often seated in close proximity to doors. Moreover, the interior surface of doors can often have irregular shapes, moving parts, or other components that are difficult to clean or repair, further increasing the importance of proper protection.

Although some covers capable of somewhat shielding the interior surface of a car door may exist, such covers are typically not custom-tailored to use with a car door, customizable to fit with multiple door types, convenient to attach, remove, or replace, and easy to use without compromising the functionality of the door. Moreover, many covers (if used with doors) provide limited coverage, often having only a single attachment point, leaving the cover vulnerable to being jostled, bumped, or moved, which may render the cover ineffective. Such covers may further impose a safety hazard, as a dog or a child could work its way behind the cover and become trapped between the cover and the door.

For these reasons, there are significant limitations to the current technology in the interior vehicle door cover industry. These limitations remain unaddressed in the prior art, curtailing the effectiveness and profitability of current door covers. The presently disclosed systems and methods, however, address and overcome these limitations.

### BRIEF SUMMARY

Some implementations of the disclosed systems and methods include a door guard for protecting an interior of a car door. In some cases, the door guard includes at least one cover configured to at least partially cover a door panel. In some such implementations, the cover includes one or more of a front surface, a back surface, a batting disposed between the front surface and the back surface, and a stitching securing the front surface to the back surface through the batting. In some cases, the cover has a perimeter (which may be of the same or a different material as any other portion of the cover).

In some implementations, the cover includes a folding portion. For example, the folding portion may be an edge or corner of the cover, allowing a user to effectively change the shape of the cover by folding (or unfolding) the folding portion. In some implementations, the folding portion includes a coupler configured to couple the folding portion to a back surface of the cover (e.g., so that the folding portion remains folded after folding).

In some cases, the door guard includes a coupling system for selectively attaching the cover to the interior of the car door. In some implementations, the coupling system includes a fastener secured to a back surface of the cover, and a complementary fastener secured to an anchoring system. In some implementations, the complementary fastener is configured to selectively engage with the fastener, and in some implementations the anchoring system is configured to selectively engage with the car door.

Some implementations of the anchoring system include at least one of a window clip and a door clip. While some implementations include just a window clip or just a door clip, some implementations include both a window clip and a door clip. In some cases in which the anchoring system includes the window clip, the window clip includes a base. In some cases, the base includes (or is otherwise attached to) the complementary fastener. In some cases, the window clip includes a shim coupled to the base. For example, some instances of the window clip include a shim that is configured to be inserted into the space between the door panel and the window at the base of the window, thereby taking advantage of the gap into which the window withdraws to secure the cover to the car door.

Where the anchoring system includes the door clip, in some cases the door clip has a strap. In some instances, the strap includes (or is otherwise attached to) the complementary fastener. In some instances, the door clip includes a tab coupled to the strap. The tab may be inserted into a gap in the car door (e.g., between the door panel and the door frame), thereby securing the door clip—and consequently the cover—to the door via the tab.

Some implementations of the door guard include a complementary fastener that is configured to selectively engage with the fastener at a plurality of points proximate to a perimeter of the cover. For example, the fastener may be disposed along one or more edges of the cover, allowing the complementary fastener to be attached to the fastener at any point (or at multiple points) along the length of such edges. Where the fastener is disposed along a first edge and a second edge, the first edge and the second edge may be adjacent to each other (e.g., an upper edge and a right-side edge), or the first and the second edge may be opposite one another (e.g., an upper edge and a lower edge). In some cases, the fastener is disposed along all the edges of the cover. In some cases, the fastener is disposed in another location on the cover, such as towards the middle.

Some implementations of the disclosed systems and methods include a method of manufacturing a door guard for protecting an interior of a car door. In some such cases, the method includes obtaining a cover configured to at least partially cover a door panel. In some cases, the method includes forming a coupling system configured to selectively attach the cover to the interior of the car door. The cover may be any cover described herein, and the coupling system may be any coupling system described herein. Moreover, such components may be obtained or formed in any suitable manner.

For example, in some instances, the “obtaining the cover” includes forming the cover. In some cases, forming the cover includes one or more of the following: obtaining a first material for forming a front surface; obtaining a second material for forming a back surface; obtaining a third material for forming a batting; disposing the third material between the first material and the second material; attaching the first material to the second material through the third material; and attaching a perimeter to each of a plurality of edges of the cover.

In some implementations of the method, the coupling system includes a fastener and a complementary fastener configured to selectively engage with the fastener. Relatedly, in some cases, the forming the coupling system comprises attaching the fastener to the cover and attaching the complementary fastener to an anchoring system configured to selectively engage with the car door. In some implementations, the complementary fastener is configured to selectively engage with the fastener at a plurality of points positioned proximate to a perimeter of the cover.

In some implementations, the anchoring system has at least one of a window clip and a door clip. Where the anchoring system has a window clip, in some cases the window clip includes a base (which may further include the complementary fastener). In some cases, the window clip includes a shim coupled to the base. Similarly, where the anchoring system has a door clip, in some cases the door clip has a strap (which may further include the complementary fastener). In some cases, the door clip has a tab coupled to the strap.

Some implementations of the disclosed systems and methods include a method of protecting an interior of a car door. In some cases, the method includes one or more of the following: obtaining a cover having a fastener; obtaining a clip having a complementary fastener; attaching the clip to the car door; and attaching the fastener to the complementary fastener. The components used to carry out this method may be any of the components discussed herein. For example, in some cases, the clip includes at least one of a window clip (including a base that includes the complementary fastener, and a shim coupled to the base) and a door clip (including a strap that includes the complementary fastener, and the tab).

Additional implementations of the disclosed systems and methods will become evident through the description of the drawings and detailed description provided below.

### BRIEF DESCRIPTION OF THE DRAWINGS

The objects and features of the present disclosure will become more fully apparent from the following description and appended claims, taken in conjunction with the accompanying drawings. Understanding that these drawings depict only typical embodiments of the disclosed systems and methods and are, therefore, not to be considered limiting of its scope, the systems and methods will be described and explained with additional specificity and detail through the use of the accompanying drawings in which:

FIG. 1A shows a frontal elevation view of a door cover as used to protect an interior of a car door in accordance with a representative embodiment of the disclosed systems and methods.

FIG. 1B shows a frontal elevation view of the door cover of FIG. 1A in an alternative configuration in accordance with a representative embodiment of the disclosed systems and methods.

FIG. 2A shows a rear elevation view of a door cover in accordance with a representative embodiment of the disclosed systems and methods.

FIG. 2B shows a rear elevation view of the door cover of FIG. 2A in an alternative configuration in accordance with a representative embodiment of the disclosed systems and methods.

FIG. 3 shows a side perspective view of a door cover in accordance with a representative embodiment of the disclosed systems and methods.

FIGS. 4A and 4B show a frontal elevation view of a lower portion of a door cover, illustrating one way in which the lower portion of the door cover may be selectively attached to the car door in accordance with a representative embodiment of the disclosed systems and methods.

FIG. 5 shows a window clip as a component of a door guard in accordance with a representative embodiment of the disclosed systems and methods.

### DETAILED DESCRIPTION

A description of embodiments will now be given with reference to the Figures, wherein like reference numbers indicate identical or functionally similar elements. It is expected that the present systems and methods may take many other forms and shapes, hence the following disclosure is intended to be illustrative and not limiting, and the scope of the disclosure should be determined by reference to the appended claims.

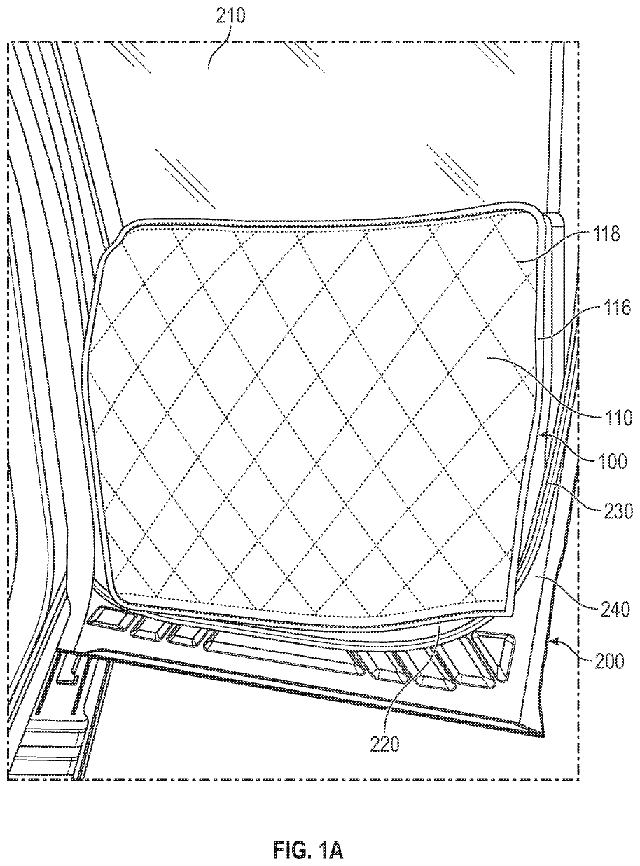

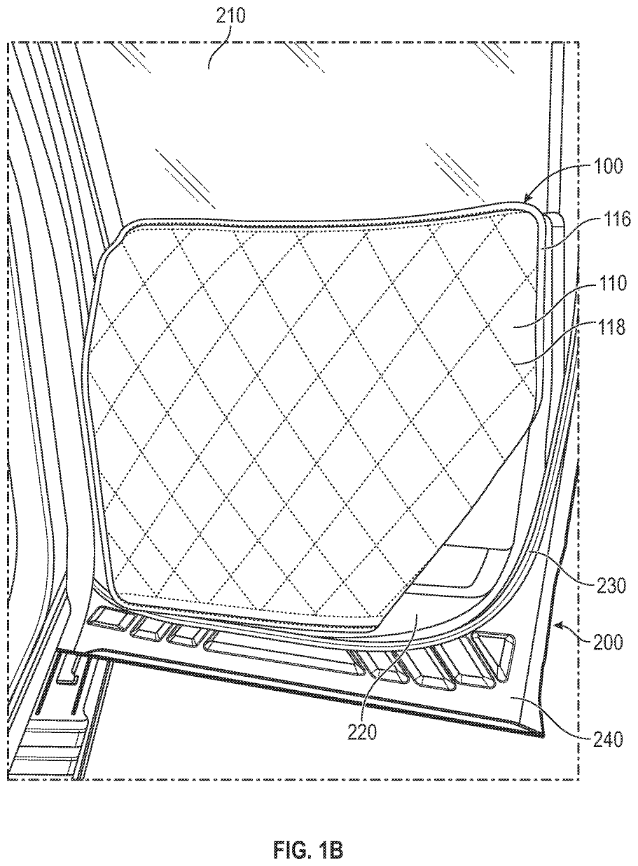

As illustrated by FIGS. 1A-1B, some embodiments of the disclosed systems and methods include a door guard 100 for protecting an interior of a vehicle door 200. In some cases, the door guard 100 includes a cover 110 configured to cover a door panel 220 (at least partially). Generally speaking, a door panel is the interior portion of a vehicle door 200 that contains functional elements such as a handle, a lock, electronics for controlling the door's window, a cupholder, and other elements. The door panel 220 may also include aesthetic elements such as upholstery, molded plastic, and other decorative features. The door guard 100 may provide protection for some or all of these features.

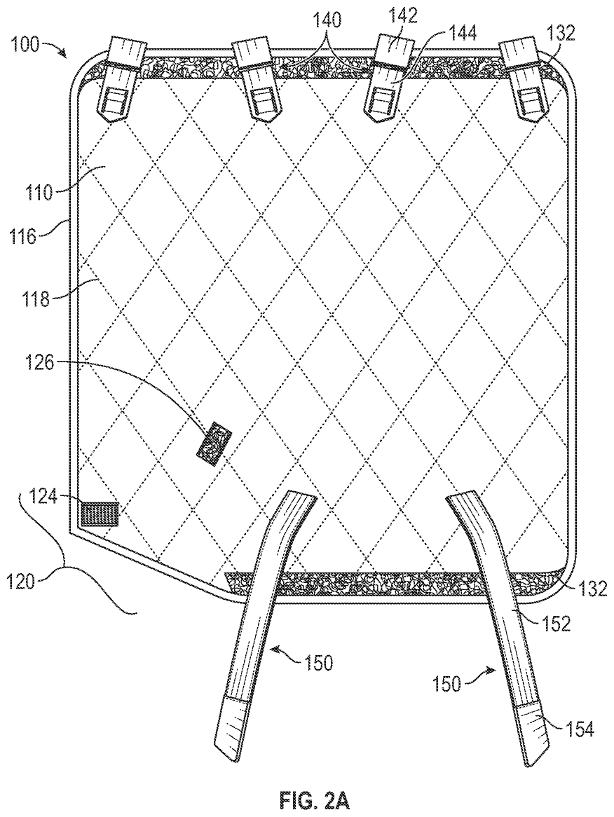

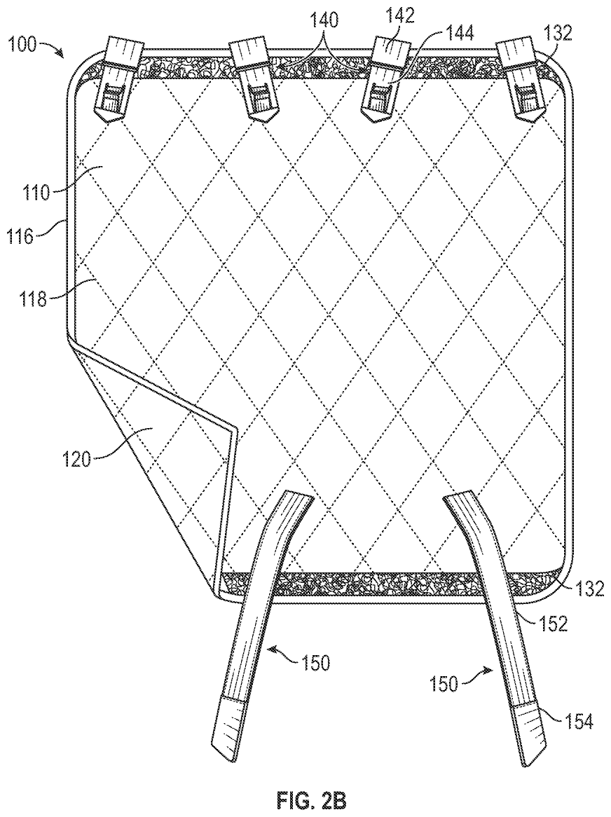

In some embodiments, the cover 110 includes one or more of a front surface (e.g., the surface that is visible in FIGS. 1A-1B), a back surface (e.g., the surface facing toward the door panel 220 in FIGS. 1A-1B, or the surface shown in FIGS. 2A-2B), a batting disposed between the front surface and the back surface (not shown), a stitching 118 (e.g., securing the front surface to the back surface through the batting), and a perimeter 116.

In some embodiments, one or more of the front surface and the back surface has one or more features for increasing the protective capabilities or convenience of the door guard 100. For example, a surface may have a smooth surface or a textured surface or a protective coating (e.g., a water-resistant coating, an oil-resistant coating, an odor-resistant coating, etc.). A surface may be made of a material that is durable, spill-resistant, electro-static resistant, or otherwise useful for providing protection against damage, deterioration, or dirtying. In some embodiments, one or more parts of the cover 110 may be constructed of a fabric material, such as, for example, one or more of the following: spandex knit, lycra knit, jersey knit, interlock knit, ribbed knit, terry knit, sweater knit, modal knit, hemp knit, bamboo knit, silk knit, cotton knit, ponte de roma, thermal knit, stretch lace, synthetic knit, organic knit, polyvinyl chloride, cotton, nylon, polyester, etc. In some embodiments, the fabric material may be stretchable. In some embodiments, the fabric material may be weather-proof and/or machine-washable.

In some embodiments, the cover 110 has only a single layer of material, whereas in some embodiments the cover has two, three, four, or any other number of layers. Where there are multiple layers, the layers may be sewn together (such as with stitching 118), appended through the use of an adhesive, or otherwise attached together in any suitable manner. In some embodiments, one material is used for the front surface and another material is used for the back surface (whereas in other embodiments, the same material is used for both). For example, in some materials the back surface is softer than the front surface so as to avoid damaging the door panel 220. As another example, the back surface may have a higher friction coefficient than the front surface so as to avoid sliding around on the door panel, while still providing a comfortable experience on the interior-facing portion of the cover 110. In some embodiments, the cover 110 includes a batting or padding. Like the surfaces, the batting can be configured to provide additional comfort or protection, and can be made of any suitable material (such as any of the materials listed above).

In some embodiments, the cover has a perimeter 116. While the perimeter 116 may be a seam, an additional stitching, or any other suitable perimeter, in some cases the perimeter 116 is formed of a separate piece of material that is folded over the edges of the surfaces and attached (e.g., through sewing or another suitable means) to said edges. While the perimeter 116 (and thus, the general shape of the cover 110) may be generally square, rectangular, or otherwise regularly polygonal, in some embodiments the perimeter is contoured to better fit the shape of a door panel 220. Where the perimeter 116 has corners, some or all of the corners may be rounded.

In some embodiments, the cover 110 includes one or more folding portions (e.g., folding portion 120 of FIGS. 2A-2B). For example, FIG. 1B shows the door guard 100 of FIG. 1A in a configuration where the lower right corner of the cover 110 has been folded between the door panel 220 and the remainder of the cover 110. That said, any portion or portions of the cover may be configured to fold (and in some cases selectively remain folded) so as to provide access to a cupholder, a window control, a door handle, or any other feature or portion of the door panel 220. In some embodiments, the folding portion may be an edge or corner of the cover 110, allowing a user to effectively change the shape of the cover by folding (or unfolding) the folding portion. In some implementations, the folding portion includes a folding coupling system configured to couple the folding portion to a back surface of the cover (e.g., so that the folding portion remains folded after folding).

In some embodiments, the cover 110 has one or more additional features, such as one or more slits (e.g., for accessing portions of the door panel 220), pockets (e.g., for storing various items), or other features. Such features may be on the front surface, back surface, or both.

As mentioned above, FIGS. 2A-2B show the reverse side of the door guard 100 shown in FIGS. 1A-1B. As shown in FIGS. 2A-2B, many of the features of the cover 110 are, in some embodiments, visible from the reverse side as well as the front (such as the perimeter 116 and the stitching 118). Moreover, FIGS. 2A-2B show that, in some embodiments, the folding portion 120 includes a folding fastener 124 and a complementary folding fastener 126 configured to selectively couple to the folding fastener 124, thereby allowing the folding portion 120 to remain folded (in accordance with the configuration shown in FIG. 2B). As with the fastener 132 and the complementary fastener 134 discussed below, the folding fastener 124 and complementary folding fastener 126 may be any suitable complementary connectors disposed in any suitable locations on the cover 110 to allow for the folding portion 120 to remain selectively folded.

With further reference to FIGS. 2A-2B, some embodiments of the door guard 100 include a coupling system for selectively anchoring the cover 110 to the interior of a vehicle door 200.

In some embodiments, the coupling system includes a fastener 132 secured to a back surface of the cover 110, and a complementary fastener 134 secured to an anchoring system. In some embodiments, the complementary fastener 134 is configured to selectively engage with the fastener 132, thereby allowing a user to selectively couple the anchoring system to the cover 110. In some embodiments, the anchoring system is configured to selectively engage with the car door 200. Accordingly, in some embodiments, the anchoring system may be selectively attached to the car door (e.g., in a user's desired configuration), and then the cover then may be selectively secured to the anchoring system by attaching the fastener 132 to the complementary fastener 134. Alternatively, the anchoring system may be selectively anchored to the car door 200 while the fastener 132 and complementary fastener 134 are engaged.

In the Figures, the fastener 132 and complementary fastener 134 are generally represented as the two sides of a hook-and-loop fastener, such as VELCRO™ (with the fastener 132 shown as the “loop” portion and the complementary fastener shown as the “hook” portion). However, each of the fasteners 132, 134 may include any suitable complementary connectors, such as zippers, buttons, snaps, magnets, clasps, eyelets and hooks, screws and threads, clips, friction- or interference-fit fasteners, ties, or any other components capable of allowing a user to selectively attach the anchoring system to the cover 110.

Moreover, while the Figures show the fastener 132 to be disposed along a top and bottom edge of the cover 110, the positioning of the fastener 132 is not limited to this configuration. Indeed, in some embodiments the fastener 132 is disposed along part or all of a top or bottom edge of the cover 110, in some embodiments the fastener is (only or additionally) disposed in another location on the cover 110. For example, in some embodiments the fastener 132 is disposed along the left edge or right edge of the cover (or both), and in some embodiments it is disposed near the center of the cover 110. In some embodiments, the fastener 132 runs alongside all or part (or multiple parts) of the perimeter 116. In some embodiments, the fastener 132 is included only in select locations on the cover 110, such as at specified points near the perimeter 116. In other embodiments, the entirety or majority of the back surface of the cover 110 includes the fastener 132.

In some embodiments, the anchoring system includes at least one of a window clip 140, a door clip 150, and another type of clip. Indeed, while some embodiments include just a window clip 140 or just a door clip 150 (or even an anchoring system without either type of clip), some embodiments include both a window clip 140 and a door clip 150. In some embodiments, the window clip 140 is configured to be inserted into the slit between the interior of a car window (e.g., 210 of FIGS. 1A-1B) and the door panel (e.g., 220 of FIGS. 1A-1B) or otherwise attach to the window of the car (or the window “seat” into which the window is designed to retract). In some embodiments, the door clip is configured to be inserted between the door panel (e.g., 220 of FIGS. 1A-1B) and the frame of the door (e.g., 240 of FIGS. 1A-1B) or otherwise attach to the car door (e.g., 200 of FIGS. 1A-1B).

In some embodiments in which the anchoring system includes one or more window clips 140, one or more of the window clips 140 includes a base 142. In some cases, the base 142 includes (or is otherwise attached to) the complementary fastener 134. In some cases, the window clip 140 includes a shim 144 coupled to the base 142. In some cases, the shim 144 is configured to be inserted into the space between the door panel and the window at the base of the window, thereby taking advantage of the gap into which the window withdraws (in order to secure the window clip 140).

In some embodiments, the door guard 100 does not include any window clips 140. Indeed, in some embodiments, one or more door clips 150 are sufficient to hold the cover 110 in place independently of (or without the inclusion of) window clips 140.

In some embodiments in which the anchoring system includes one or more door clips 150, one or more of the door clips 150 has a strap 152. In some instances, the strap 152 includes (or is otherwise attached to) the complementary fastener 134. In some embodiments, the door clip 150 includes a tab 154 coupled to the strap 152. In some cases, the tab 154 is configured to be inserted into the space between the door panel and the door frame, thereby taking advantage of the gap between the door panel and the door frame (in order to secure the door clip 150). In some cases, the door clips 150 include other types of door clips entirely; for example, the door clips 150 may include and of the fasteners and complimentary fasteners discussed herein, where one of the fastener or complimentary fastener is attached to the door frame 240 or to another part of the door 200, and where the other of the fastener or complimentary fastener takes the place of the tab 154 shown in the Figures. Accordingly, in some embodiments, the door clip selectively attaches to a magnet, a hook and loop fastener, a screw, a bolt, an eyelet, or another type of fastener that is attached to the door directly, and in some embodiments the door clip attaches to the door frame 240, the door panel 220, or another part of the door directly. In some embodiments, the door clips 150 include one or more clamps, clasps, hooks, screws, or other means for selectively attaching the door clips 150 to the door 200.

In some embodiments, the anchoring system includes one or more other clips. Like the door clips 150, such clips may attach to the door 200 or a part thereof (such as the door frame 240 or the door panel 220), but such clips may also attach to other parts of the car, such as one or more seats, body components (e.g., the cab of the car), mats, headrests, covers, seatbelts, anchor points, or other parts of the vehicle.

In some embodiments, instead of (or in addition to) using a fastener 132 and a complementary fastener 134 to selectively attach the anchoring system (i.e., the one or more window clips 140, the one or more door clips 150, other types of clips, or any combination of some or all of the foregoing or portions thereof) to the door 200, the anchoring system may be permanently or semi-permanently attached to the cover 110. For example, in some embodiments, the anchoring system (or any particular clip or any part thereof) is attached to the cover 110 (at any point or points on the cover, such as on any edge, perimeter, center, or other location) through sewing, stitching, welding, riveting, gluing, screwing, bolting, soldering, anchoring, chemical bonding, or other permanent or semi-permanent attachment mechanisms. Thus, in some embodiments, any selective attachment mechanism discusses herein is interchangeable with a non-selective attachment mechanism without comprising the functionality of the door guard 100.

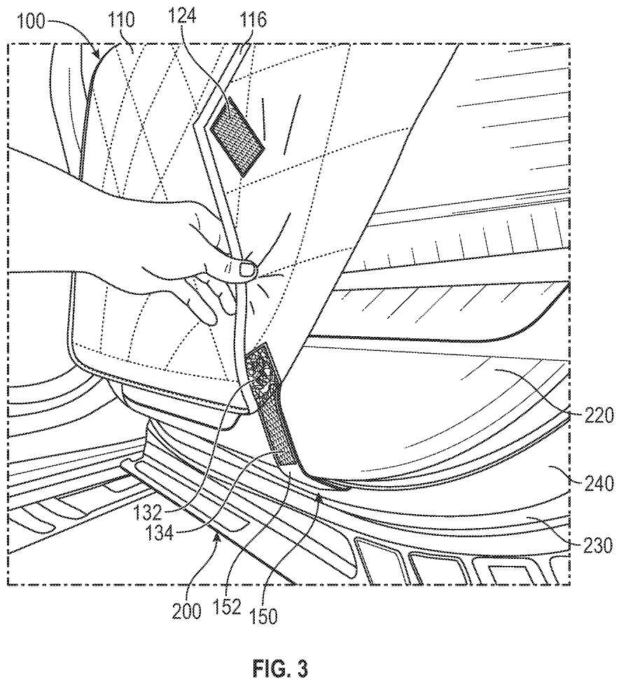

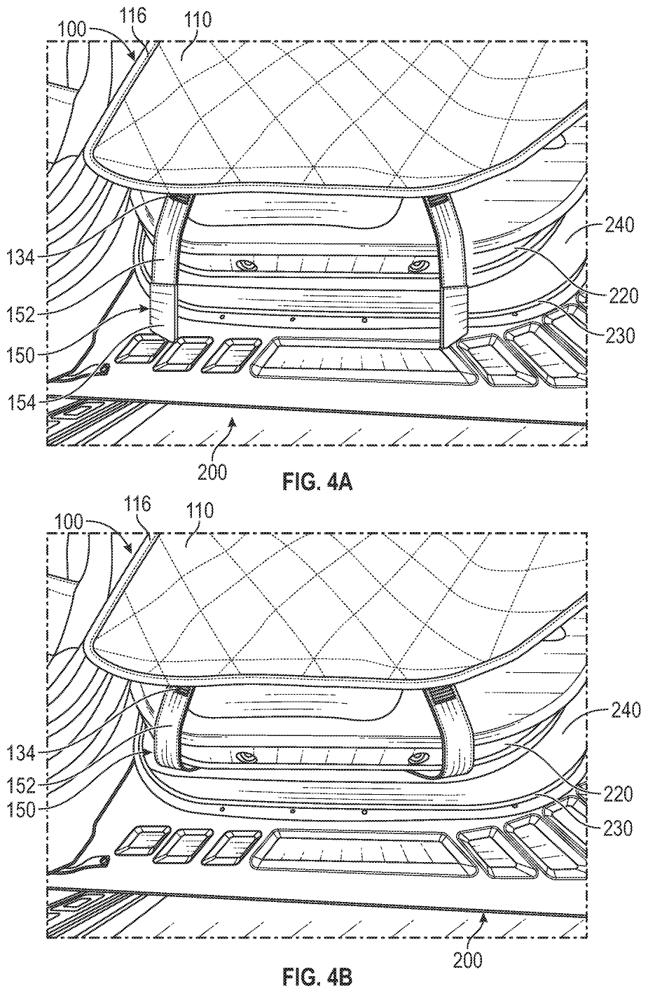

FIGS. 3 and 4A-4B illustrate an example use of a door clip 150 of a door guard 100 in accordance with some embodiments. As shown in these Figures, a door clip 150 having a tab 154 and a strap 152) can be selectively secured to a cover 110 by attaching a complementary fastener 134 that is secured to the strap 152 to a fastener 132 that is secured to the cover 110 (e.g., proximate the perimeter 116 of the cover 110). The tab 154 can be inserted into a space between the door panel 220 and the door frame 240 (e.g., proximate the door seal 230) in order to selectively secure the cover 110 to the door 200. The tab may also be inserted into any other suitable crack, crevice, slit, space, or interface. In some embodiments, this configuration allows a bottom, a side, or another portion of the cover 110 to be secured so as not to hang loose or flap. Indeed, in some embodiments, multiple clips used together (e.g., multiple door clips, multiple window clips, door clips and window clips, etc.) are used to anchor multiple sides of the cover 110 to eliminate or reduce the risk of a child or animal crawling into the space between the door panel 220 and the door guard 100 and provide more comprehensive protection of the door panel 220. Moreover, in some embodiments the position of the clips can be freely adjusted by adjusting the attachment points of the complementary fastener 134 to the fastener 132. Thus, an optimal position can be found for multiple types of vehicle doors, which are not all built identical to each other.

In some embodiments, the strap 152 of the door clip 150 has an elastic quality. Thus, when the tab 154 is inserted to a space such that the tab 154 and the strap 152 are oriented in a similar direction (see FIG. 3), the strap 152 may bias the tab 154 toward the cover, thereby holding the tab 154 in place.

In some embodiments, other types of window clips and door clips may be used. Indeed, the use of clips that are attached to the complementary fastener 134 allows for easy and convenient interchanging of clips (e.g., multiple different types of clips may have the same type of complementary fastener 134, so that multiple types of clips may be used with a single type of fastener 132 on the cover 110).

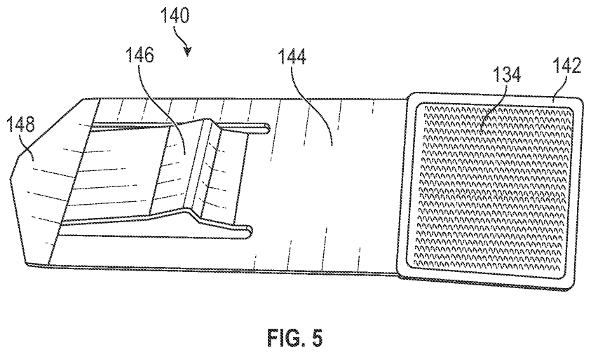

Turning now to FIG. 5, FIG. 5 illustrates an example of one type of window clip 140 that can be used with some embodiments of the described systems and methods. In some embodiments, the window clip 140 includes one or more of a base 142 and a shim 144. In some embodiments, the shim 144 further includes a tip 146. In some cases, the tip 146 is angled with respect to a plane of the shim 144 (which may help the clip to remain in place when inserted into the gap at the base of a window). In some embodiments, the tip 146 is chamfered toward the center of a longitudinal axis of the clip, coming to a flat, blunt point near the center of the longitudinal axis (thereby facilitating easier insertion into the window gap without damaging the window sealing). In some embodiments, the shim 144 further includes a protrusion 146, further stabilizing the clip when it is properly inserted. In some embodiments, the base 142 includes the complementary fastener 134, as described above.

Some embodiments of the disclosed systems and methods include methods of making or using a door guard, such as the door guard 100 of FIGS. 1A-5.

Indeed, some embodiments include a method of manufacturing a door guard 100 for protecting an interior of a car door 200. In some such embodiments, the method includes obtaining a cover 110 configured to at least partially cover a door panel 220. In some cases, the method includes forming a coupling system configured to selectively attach the cover 110 to the interior of the car door 200. The cover 110 may include any cover described herein, and the coupling system may include any coupling system described herein. Moreover, such components may be obtained or formed in any suitable manner.

For example, in some embodiments, “obtaining the cover” includes forming the cover 110. In some cases, forming the cover 110 includes one or more of the following: obtaining a first material for forming a front surface; obtaining a second material (which may be the same as or different from the first material) for forming a back surface; obtaining a third material for forming a batting (which, again, may be the same as or different from the first or second material); disposing the third material between the first material and the second material; attaching the first material to the second material through the third material (e.g., through sewing); and attaching a perimeter to each of a plurality of edges of the cover. In some embodiments, the method includes selecting suitable materials for use in accomplishing the foregoing (e.g., selecting the materials from any of the materials discussed herein or any other suitable materials). In some embodiments, the method further includes one or more of creating one or more slits in or through the cover, attaching one or more pockets to the cover, or reinforcing the cover (e.g., by coating it with a protective coating). In some embodiments, the method includes shaping the cover 110 (e.g., by cutting or folding material) to correspond with the shape of a door panel 220 or to otherwise have a suitable cover shape (as discussed herein). In some embodiments, the method includes adding a folding portion 120 to the cover 110, such as by creasing the cover 110, adding a folding fastener 124 and a complementary folding fastener 126, or otherwise adjusting the cover to create a portion that is more suited to folding than other portions of the cover.

In some embodiments of the method, the coupling system includes a fastener 132 and a complementary fastener 134 configured to selectively engage with the fastener 132. Relatedly, in some cases, “forming the coupling system” includes attaching the fastener 132 to the cover 110 and attaching the complementary fastener 134 to an anchoring system configured to selectively engage with the car door 200. In some embodiments, the complementary fastener 134 is configured to selectively engage with the fastener 132 at a plurality of points positioned proximate to a perimeter 116 of the cover 110 (or otherwise disposed in various positions on the cover 110, as discussed above); accordingly, some embodiments of the method include configuring the fastener 132 and complementary fastener 134 to have any of the functionality described herein.

In some embodiments, the method includes obtaining (e.g., by forming) the anchoring system with at least one of a window clip 140 and a door clip 150. Where the anchoring system has a window clip 140, in some cases the window clip includes a base 142 (which may further include the complementary fastener 134). In some cases, the window clip includes a shim 144 coupled to the base 142. Similarly, where the anchoring system has a door clip 150, in some cases the door clip has a strap 152 (which may further include the complementary fastener 134). In some cases, the door clip 150 has a tab 154 coupled to the strap 152.

Some implementations of the disclosed systems and methods include a method of protecting an interior of a car door 200. In some cases, the method includes one or more of the following: obtaining a cover 110 having a fastener 132; obtaining a clip having a complementary fastener 134; attaching the clip to the car door; and attaching the fastener 132 to the complementary fastener 134. The components used to carry out this method may be any of the components discussed herein. For example, in some cases, the clip includes at least one of a window clip 140 (e.g., including a base 142 that includes the complementary fastener 134, and a shim 144 coupled to the base 142) and a door clip 150 (e.g., including a strap 152 that includes the complementary fastener 134, and the tab 154).

The methods described herein may further include forming any of the components described herein, attaching them together in any suitable manner, or using them in any manner consistent with this disclosure.

The described systems and methods may be embodied in other specific forms without departing from their spirit or essential characteristics. The described embodiments, examples, and illustrations are to be considered in all respects only as illustrative and not restrictive. The scope of the described systems and methods is, therefore, indicated by the appended claims rather than by the foregoing description. All changes that come within the meaning and range of equivalency of the claims are to be embraced within their scope. Moreover, any component and characteristic from any embodiments, examples, and illustrations set forth herein can be combined in any suitable manner with any other components or characteristics from one or more other embodiments, examples, and illustrations described herein.

As used herein, the singular forms “a”, “an”, “the” and other singular references include plural referents, and plural references include the singular, unless the context clearly dictates otherwise. For example, reference to a fastener includes reference to one or more fasteners, and reference to clips includes reference to one or more clips. In addition, where reference is made to a list of elements (e.g., elements a, b, and c), such reference is intended to include any one of the listed elements by itself, any combination of less than all of the listed elements, and/or a combination of all of the listed elements. Moreover, the term “or” by itself is not exclusive (and therefore may be interpreted to mean “and/or”) unless the context clearly dictates otherwise. Furthermore, the terms “including”, “having”, “such as”, “for example”, “e.g.”, and any similar terms are not intended to limit the disclosure, and may be interpreted as being followed by the words “without limitation”.

In addition, as the terms “on”, “disposed on”, “attached to”, “connected to”, “coupled to”, etc. are used herein, one object (e.g., a material, element, structure, member, etc.) can be on, disposed on, attached to, connected to, or otherwise coupled to another object-regardless of whether the one object is directly on, attached, connected, or coupled to the other object, or whether there are one or more intervening objects between the one object and the other object. Also, directions (e.g., “front”, “back”, “on top of”, “below”, “above”, “top”, “bottom”, “side”, “up”, “down”, “under”, “over”, “upper”, “lower”, “lateral”, “right-side”, “left-side”, “base”, etc.), if provided, are relative and provided solely by way of example and for ease of illustration and discussion and not by way of limitation.

What is claimed is:

1. A door guard for protecting an interior of a car door, the door guard comprising:
a cover configured to at least partially cover a door panel; and
a coupling system for selectively attaching the cover to the interior of the car door.

2. The door guard as recited in claim 1, wherein the cover comprises a front surface, a back surface, a batting disposed between the front surface and the back surface, and a stitching securing the front surface to the back surface through the batting.

3. The door guard as recited in claim 1, wherein the cover comprises a folding portion that comprises a coupler configured to couple the folding portion to a back surface of the cover.

4. The door guard as recited in claim 1, wherein the coupling system comprises:
a fastener secured to a back surface of the cover; and
a complementary fastener secured to an anchoring system, wherein the complementary fastener is configured to selectively engage with the fastener, and the anchoring system is configured to selectively engage with the car door.

5. The door guard as recited in claim 4, wherein the anchoring system comprises at least one of a window clip and a door clip.

6. The door guard as recited in claim 5, wherein the anchoring system comprises the window clip, and wherein the window clip comprises:
a base comprising the complementary fastener; and
a shim coupled to the base.

7. The door guard as recited in claim 5, wherein the anchoring system comprises the door clip, and wherein the door clip comprises:
a strap comprising the complementary fastener; and
a tab coupled to the strap.

8. The door guard as recited in claim 4, wherein the complementary fastener is configured to selectively engage with the fastener at a plurality of points proximate to a perimeter of the cover.

9. The door guard as recited in claim 8, wherein the plurality of points are disposed proximate to at least a first edge of the cover and a second edge of the cover.

10. The door guard as recited in claim 9, wherein the first edge is positioned opposite the second edge.

11. A method of manufacturing a door guard for protecting an interior of a car door, the method comprising:
obtaining a cover configured to at least partially cover a door panel; and
forming a coupling system configured to selectively attach the cover to the interior of the car door.

12. The method of claim 11, wherein the obtaining the cover comprises forming the cover, and wherein the forming the cover comprises:
obtaining a first material for forming a front surface;
obtaining a second material for forming a back surface;
obtaining a third material for forming a batting;
disposing the third material between the first material and the second material;
attaching the first material to the second material through the third material.

13. The method of claim 12, wherein the forming the cover further comprises attaching a perimeter to each of a plurality of edges of the cover.

14. The method of claim 11, wherein the coupling system comprises a fastener and a complementary fastener configured to selectively engage with the fastener, and wherein the forming the coupling system comprises attaching the fastener to the cover and attaching the complementary fastener to an anchoring system configured to selectively engage with the car door.

15. The method of claim 14, wherein the complementary fastener is configured to selectively engage with the fastener at a plurality of points positioned proximate to a perimeter of the cover.

16. The method of claim 14, wherein the anchoring system comprises at least one of a window clip and a door clip.

17. The method of claim 16, wherein the anchoring system comprises the window clip, and wherein the window clip comprises:
a base comprising the complementary fastener; and
a shim coupled to the base.

18. The method of claim 16, wherein the anchoring system comprises the door clip, and wherein the door clip comprises:
a strap comprising the complementary fastener; and
a tab coupled to the strap.

19. A method of protecting an interior of a car door, the method comprising:
obtaining a cover comprising a fastener;
obtaining a clip comprising a complementary fastener;
attaching the clip to the car door;
attaching the fastener to the complementary fastener.

20. The method of claim 19, wherein the clip comprises at least one of:
(a) a window clip comprising:
(i) a base comprising the complementary fastener; and
(ii) a shim coupled to the base; and
(b) a door clip comprising:
(i) a strap comprising the complementary fastener; and
(ii) a tab coupled to the strap.
